(19) United States
(12) Patent Application Publication
(10) Pub. No.: US 2026/0110464 A1
(43) Pub. Date: Apr. 23, 2026

(54) BAROCALORIC HEAT PUMPS

(71) Applicant: University of Louisville Research Foundation, Inc., Louisville, KY (US)

(72) Inventors: Bikram Bhatia, Louisville, KY (US); Naveen Weerasekera, Louisville, KY (US)

(21) Appl. No.: 19/365,656

(22) Filed: Oct. 22, 2025

Related U.S. Application Data
(60) Provisional application No. 63/710,809, filed on Oct. 23, 2024.

(51) Int. Cl. F25B 30/02; C09K 5/14

(52) U.S. Cl. CPC F25B 30/02; C09K 5/14

(57) ABSTRACT

A heat pump based on the colossal barocaloric effect comprises a barocaloric material positioned within a rigid barocaloric refrigerant core and configured to receive intermittently an applied mechanical force that compresses the barocaloric material to release heat to a heat transfer medium, the pump arranged to circulate the heat transfer medium into, through, and out of the barocaloric refrigerant core wherein, upon exiting, warmer heat transfer medium enters one of two thermal reservoirs configured with a heat exchanger that extracts energy from the heat transfer medium undergoing a positive temperature differential due to exposure to the heat released from the barocaloric material; cyclical operation is enabled by a second thermal reservoir that receives cooler heat transfer medium following the absorption of energy by the barocaloric material as it is decompressed by the removal of the applied force.

### CROSS-REFERENCE TO RELATED APPLICATIONS

This patent application claims the benefit of and priority to U.S. Provisional patent application Ser. No. 63/710,809 with a filing date of Oct. 23, 2024, the contents of which are fully incorporated herein by reference.

### STATEMENT OF GOVERNMENT INTEREST

This invention was made with government support under 80NSSC20M0047 awarded by NASA. The government has certain rights in the invention.

### FIELD OF INVENTION

The disclosures herein relate to novel solid-state refrigeration and/or heating systems, apparatuses, and methods that employ temperature and entropy changes from repeated compression/decompression hydrostatic pressure cycles, also known as barocaloric heating and cooling.

### BACKGROUND

Traditional refrigeration systems that employ vapor compression principles are relatively inefficient, unreliable, and demonstrate potential ozone depletion and global warming effects. In an effort to develop alternatives, various solid-state cooling technologies have been investigated or developed, including those based on electrocaloric (EC), magnetocaloric (MC), and elastocaloric effects (eC). However, there also are potential drawbacks regarding efficiency, scalability and cost associated with these alternatives, which tend to necessitate a tradeoff between cooling/heating power, coefficient of performance, and operating temperature span.

In addition to these approaches, barocaloric approaches to heating and cooling also have been investigated, as offering advantages like enhanced energy efficiency, low cost, reduced environmental impact, and scalability. A range of compressible barocaloric materials are available that undergo adiabatic temperature changes when compressed and decompressed under hydrostatic pressure over multiple cycles to facilitate heat transfer.

Even so, possible challenges on the practical application of a barocaloric approach also have been noted, including the ability to develop suitable enclosures with low thermal mass yet capable of withstanding large hydrostatic pressures. Practical applications in barocaloric cooling and heating are based on the colossal barocaloric effect, which occurs when certain materials experience a large change in entropy or temperature in response to applied or removed pressure and is observable at relatively high pressures (>0.1 Gigapascals, GPa). The ability to utilize the colossal barocaloric effect introduces noted engineering complexities in maintaining what are relatively extreme operating conditions, while providing thermal management between a barocaloric refrigerant material (or, referred to as barocaloric material herein) and the external environment. However, addressing such challenges as these is important toward advancing the field in order to develop next-generation solid-state cooling and heat-pumping devices based on the properties and uses of barocaloric materials.

### SUMMARY OF EMBODIMENTS

The embodiments disclosed herein include a barocaloric solid-state heat pump that works based on the cyclical application and release of hydrostatic pressure on a barocaloric material. An exemplary embodiment utilizes a mechanical force (e.g., a hydraulically driven piston) acting upon a barocaloric material. The barocaloric material is partially surrounded by a rigid barocaloric refrigerant core formed of a material, e.g., titanium (Ti). Further, the structure of the barocaloric refrigerant core is configured to establish indirect thermal contact between the barocaloric material and a heat transfer medium as it flows through the barocaloric refrigerant core. The flow of the heat transfer medium into, through, and out of the barocaloric refrigerant core enables the transfer of energy as heat obtained from the mechanical work performed in compressing the barocaloric material. Preferably, the barocaloric refrigerant core is suitable to withstand relatively high hydrostatic pressures exerted by the compression of the barocaloric material (e.g., up to 0.25 GPa). The barocaloric refrigerant core, the barocaloric material, and the heat transfer medium are arranged to facilitate efficient thermal management and heat transfer as the heat transfer medium circulates both within the barocaloric refrigerant core and between this core and thermal reservoirs as described further herein. In some embodiments, the heat transfer medium is a flowing liquid, such as ethylene glycol. In this regard, ethylene glycol is a suitable, albeit non-limiting, material for the heat transfer medium given its density (1.14 g cm⁻³), specific heat capacity (2.38 J g⁻¹K⁻¹), and thermal conductivity (0.256 W m⁻¹K⁻¹).

In some embodiments, such a heat transfer medium circulates through a refrigerant core housing a barocaloric material and in thermal contact with that barocaloric material. As discussed and shown further herein, in some embodiments the heat transfer medium flows in thermal contact with the barocaloric core while traveling between cold and hot thermal reservoirs positioned externally. The compression and decompression of the barocaloric material causes adiabatic temperature changes in the barocaloric material that is transferred to this medium, and ultimately released as heat into an external environment.

Two ways to determine performance metrics of a heat pump are specific heating power (SHP) and coefficient of performance (COP). The SHP of a heat pump is the ratio between total heat transfer to a hot thermal reservoir (QH) and the mass of the barocaloric material multiplied by total t_{contact-hot} (time from contact to a measured higher temperature).

The COP of a heat pump is the ratio between total energy transfer to a hot thermal reservoir (QH) and mechanical work input (Win) required to compress a barocaloric material to a determined hydrostatic pressure. In other words, mechanical work input to the system to compress the barocaloric material can be determined using the relationship between pressure and volumetric strain according to known mathematical formulas The mechanical work involved in the compression is converted to heat as the polymers of the barocaloric material are compressed into more stable, lower energy states.

As disclosed herein, nitrile butadiene rubber (NBR) is an exemplary (non-limiting) barocaloric material. The scope of embodiments herein is not limited by a particular barocaloric refrigerant material selected. For example, additional materials suitable as a barocaloric refrigerant in the context of the present disclosures include, but are not limited to, elastomers and other polymers, plastic crystals, liquid crystals, hybrid organic-inorganic materials, and shape memory alloys. Using ethylene glycol as an exemplary heat transfer medium and NBR under compression created by force exerted by a piston-cylinder arrangement, a heat pump in accordance with present embodiments achieved a COP of 4.2 and a SHP of 0.036 W g⁻¹.

Accordingly, the practice of multiple embodiments discussed herein provide for heat pumps that demonstrate high thermal conductivity while showing large barocaloric response and perform comparably to other known devices (vapor compression systems, EC, MC, eC) as a barocaloric cooling device. Stated differently, a barocaloric material placed inside a barocaloric refrigerant core undergoes cycles of compression followed by decompression. When the barocaloric material is compressed, such as by applying hydrostatic pressure to the barocaloric material, this releases energy that raises the temperature of the circulating heat transfer medium. This energy in the form of heat can be captured with a heat exchanger positioned outside the barocaloric refrigerant core. In turn, when the barocaloric material is allowed to decompress, by the removal of the hydrostatic pressure, the barocaloric material absorbs energy in the form of heat from the circulating heat transfer medium. The heat transfer medium is circulated within the barocaloric refrigerant core, as well as between this core and respective controlled-temperature thermal reservoirs-one designated “hot” and the other “cold” based on the relative temperatures of these reservoirs.

### BRIEF DESCRIPTION OF THE FIGURES

The drawings, schematics, figures, and descriptions are to be understood as illustrative of structures, features and aspects of the present embodiments and do not limit the scope of the embodiments. Where the figures provide or suggest dimensional information, the scope of the application is not limited to the precise arrangements, scales, or dimensions as shown in the drawings, nor as discussed in the textual descriptions.

FIG. 1 is a schematic showing temperature change effects (ΔT) from cyclical application and release of hydrostatic pressure on a barocaloric material, according to multiple embodiments and alternatives.

FIG. 2 is a graph representing the changes going from stages 4-1, 1-2, 2-3, and 3-4 in FIG. 1 throughout the cycles of compression and decompression exerted on a barocaloric material, according to multiple embodiments and alternatives.

FIG. 3A and FIG. 3B, respectively, provide two graphs that relate changes in pressure (top graph) and temperature (bottom graph) based on cyclical compression and decompression of a barocaloric material, according to multiple embodiments and alternatives.

FIG. 4A-D provide collectively a schematic that illustrates the process for an exemplary heat pump device and system, according to multiple embodiments and alternatives.

FIG. 5A is a graph representing pressure increases from mechanical work input expected from an exemplary heat transfer process.

FIG. 5B is a graph representing adiabatic temperature changes as pressure changes expected in an exemplary heat transfer process.

FIG. 6A is a schematic of a heat pump device, according to multiple embodiments and alternatives.

FIG. 6B shows a partial view of the schematic in FIG. 6A.

FIG. 7 is a CAD drawing showing a partial longitudinal cross-section of a heat pump, according to multiple embodiments and alternatives.

FIG. 8 is a partial longitudinal cross-section of a heat pump showing an optional configuration for compressing a barocaloric material (labeled as BCR for barocaloric refrigerant material), according to multiple embodiments and alternatives.

FIG. 9 is an image providing a perspective view of a surface of a barocaloric refrigerant core with an inlet and an exit of a heat pump, according to multiple embodiments and alternatives.

FIG. 10 is an image providing a partial view of a heat pump according to multiple embodiments and alternatives.

FIG. 11A shows a perspective view of an exemplary barocaloric heat pump illustrating several components of the device and system, according to multiple embodiments and alternatives.

FIG. 11B provides a flow schematic of the exemplary barocaloric heat pump illustrated I FIG. 11A, according to multiple embodiments and alternatives.

FIG. 11C is a partial longitudinal cross-sectional view of features in a barocaloric refrigerant core with hot and cold entry and circulation of a heat transfer medium, according to multiple embodiments and alternatives.

FIG. 11D is a partial longitudinal cross-sectional view of features in another alternative configuration for a barocaloric refrigerant core wherein thermal switching between hot and cold heat transfer medium is achieved using alternating solid-solid contacts, according to multiple embodiments and alternatives.

FIG. 12A is a graph showing temperature changes of a barocaloric refrigerant material, in this case NBR, during use of an exemplary heat transfer pump device, according to multiple embodiments and alternatives.

FIG. 12B is a graph showing temperature changes for an inlet (T_(hot-in)) and exit (T_(hot-out)) of the refrigerant core as a function of time for an exemplary use of such a device, according to multiple embodiments and alternatives.

FIG. 13A graphs SHP as a function of pressure, p, for an exemplary heat transfer pump as discussed in the examples, according to multiple embodiments and alternatives.

FIG. 13B graphs COP as a function of pressure, p, for the exemplary heat transfer pump as discussed in connection with FIG. 13A, according to multiple embodiments and alternatives.

### MULTIPLE EMBODIMENTS AND ALTERNATIVES

Heat pumps in accordance with the present embodiments provide an alternative to traditional vapor compression systems. The barocaloric heating/cooling in accordance with such pumps provides for substantial barocaloric response and high thermal conductivity.

In some aspects, a heat pump according to present embodiments is based on a barocaloric refrigerant core 19, in thermal contact with a fluid heat exchanger. This fluid may circulate within cylindrical sleeve around the barocaloric material to facilitate heat transfer between the barocaloric material and the circulating fluid, and vice versa. Use in refrigeration is one of many potential applications of the teachings disclosed herein.

In some embodiments, a heat pump in accordance with present embodiments may comprise a barocaloric refrigerant core 19 formed of low thermal mass materials such as titanium, within which is a rigid enclosure comprising a sleeve defining a hollow space and housing a barocaloric material. The refrigerant core and sleeve may be cylindrical and fabricated with an opening at one of its longitudinal ends, wherein the opening is configured to receive a force such as from a hydraulically driven piston that reciprocally compresses and then decompresses the barocaloric material over multiple cycles. In some embodiments, the barocaloric refrigerant core and sleeve are arranged coaxially so their openings are aligned. As the barocaloric material is compressed, heat is transferred to a heat transfer medium which may be in liquid form that travels through the refrigerant core in thermal contact with the barocaloric material within the sleeve. The heat transfer medium need not be in direct contact with the barocaloric material to achieve the needed thermal contact, but instead may flow through a series of channels outside of the sleeve yet still within a rigid barocaloric refrigerant core 19, such that a surface of the sleeve is positioned between the barocaloric material and the circulating heat transfer medium. In some embodiments, the heat transfer medium travels both internally within and externally outside of the refrigerant core, being connected with tubing formed from an appropriate material. In some embodiments, the tubing connects the refrigerant core to a plurality of thermal reservoirs, one being designated as a hot thermal reservoir and the other as a cold thermal reservoir, which in combination facilitate the maintenance of a quasi-steady-state between the system (including the heat transfer medium carried from and into the refrigerant core) and the external environment. The device and system may be equipped with one or more heat exchangers that remove heat gained by the heat transfer medium from the barocaloric material under compression, and otherwise maintain the thermal reservoirs at determined temperatures. Experimental data is provided herein, which in part reflect temperature changes of the heat transfer medium wherein a temperature upon exiting the refrigerant core is greater than a temperature upon entering this core. The temperature differential represents heat removed from the core.

As the following figures and descriptions demonstrate, the nature of barocaloric solid materials can be exploited to achieve substantial heating/cooling effects.

### Barocaloric Heat Pump Operation and Design

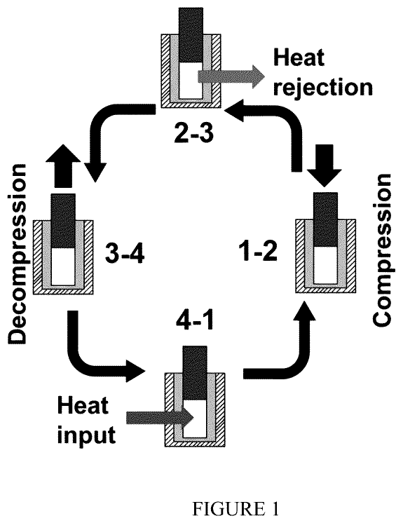

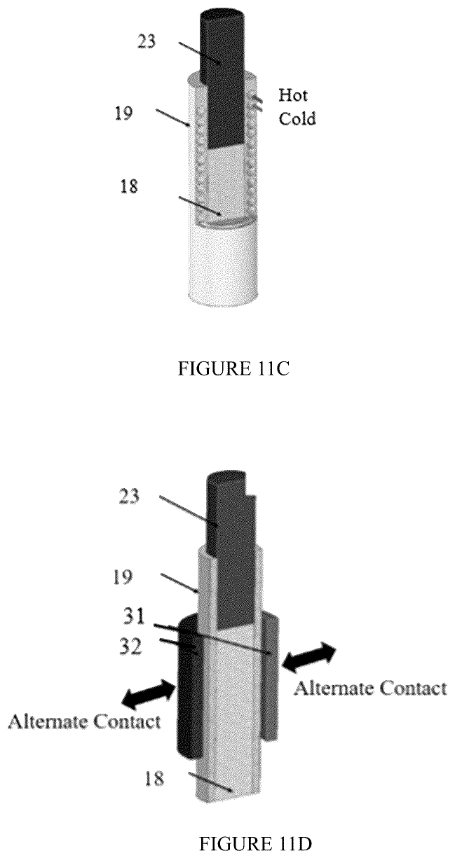

Through cyclical application and release of hydrostatic pressure on a barocaloric material confined within a refrigerant core shaped as a cylinder, heat pumping occurs between a hot thermal reservoir and a cold thermal reservoir utilizing an integrated heat exchanger. While a cylindrical shape for the refrigerant core is described here, such a configuration is merely exemplary, and other configurations can be selected without departing from the scope of teachings contained herein. For illustrative purposes, FIG. 1 provides a schematic of the heat exchange process. (Additional structures, such as the hot thermal reservoir 31 and the cold thermal reservoir 32 are shown in FIG. 11A.) In FIG. 1, heat is input to the system, the temperature rises slightly from this input, and then compression causes the temperature to rise substantially. Then heat is released/rejected in the compressed state, and then decompression causes the temperature of the barocaloric material to drop further.

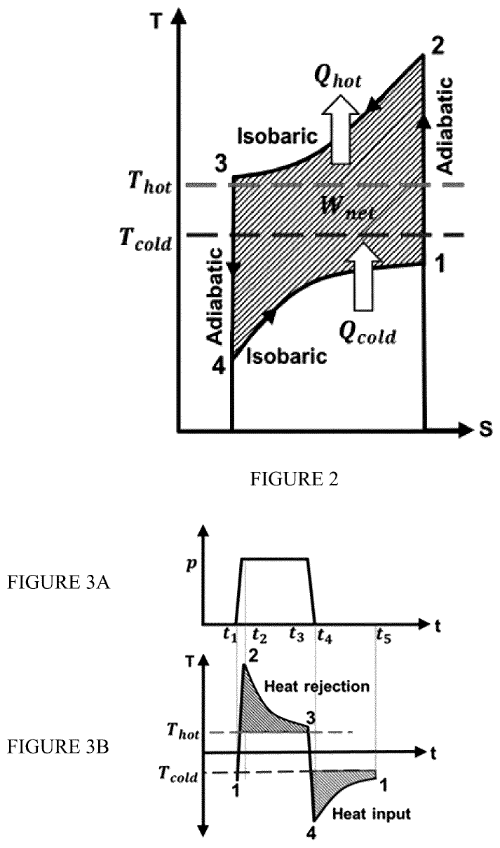

Schematically, this is seen in FIGS. 1 and 2, in which the latter graphs temperature over entropy to illustrate the adiabatic changes in the system. The point at 4-1 in FIG. 1 coincides with heat input represented by the line from point 4 to point 1 in FIG. 2, in which pressure does not change. The compression of the barocaloric material coincides with 1-2 in FIG. 1 and is represented by the line from 1 to 2 in FIG. 2, in which temperature rises significantly. This heat will be rejected at point 2-3 of FIG. 1 and returned to the hot thermal reservoir (Qₕₒₜ) denoted by the red arrow in FIG. 2. Various factors determine the efficiency of heat transfer from the barocaloric material to the hot and cold thermal reservoirs. These factors include distance traveled by the heat transfer medium and the effective thermal distance, as a function of the thermal resistance of the structures through which the heat transfer medium passes (e.g., tubing) and of the heat transfer medium itself.

As heat rejection occurs at point 2-3 of FIG. 1, the temperature drop in the system is represented by the line from 2 to 3 in FIG. 2. This is followed by decompression at point 3-4 in FIG. 1, and represented by the line from 3 to 4 in FIG. 2. Accordingly, the present embodiments encompass not only the barocaloric refrigerant material itself, but also a range of designs and implementation of a barocaloric heat pump(s) that utilize such materials effectively to achieve the heat transfer purposes set forth in this disclosure.

Table 1 summarizes the cyclical compression/decompression process described above as it relates to adiabatic temperature changes in the barocaloric material.

| Sequence | | |
|---|---|---|
| of Process | Time Span | Process Description |
| 1 to 2 | t₂-t₁ = t_{compression} | pressure applied, adiabatic temperature |
| | | rises |
| 2 to 3 | t3-t2 = t_{contact•hot} | heat is rejected to hot thermal reservoir |
| 3 to 4 | t₄-t₃ = t_{decompression} | pressure released, adiabatic temperature |
| | | drops |
| 4 to 1 | t5-t4 = t_{contact•cold} | heat is absorbed from cold thermal |
| | | reservoir |

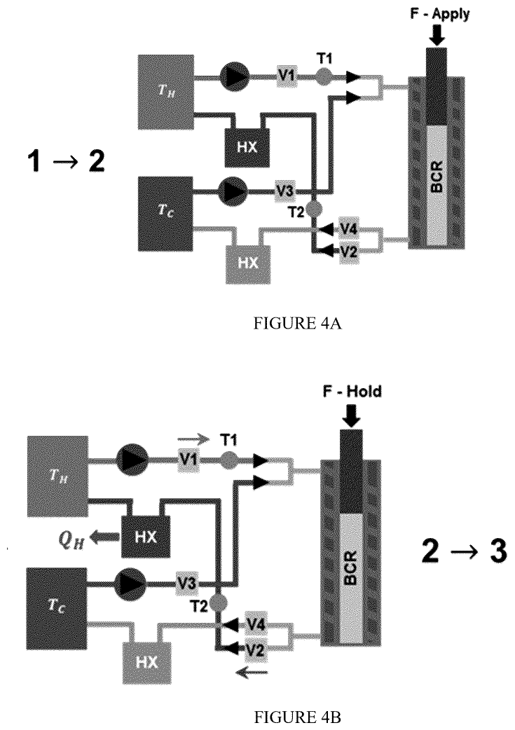

FIG. 3A and FIG. 3B are two graphs, with the top graph (FIG. 3A) representing pressure change over time during a given cycle, and the bottom graph (FIG. 3B) representing temperature fluctuations at the same time points. In the two figures, it will be seen that compression (from time point t1 to t2 in FIG. 3A increases the hydrostatic pressure and the temperature significantly. Pressure is maintained from time point t2 to t3 as shown in FIG. 3A, representing a pressure holding period while the barocaloric material transfers heat to the heat transfer medium to allow heat to be rejected from the system (coinciding with 2-3 in both FIG. 1 and FIG. 3B).

In FIG. 3A, decompression is represented by time point t3 to t4, further coinciding with a significant temperature drop going from range 3 to 4 in FIG. 3B. At this point, the circulating heat transfer medium is returned to the cold thermal reservoir. Heat input in the form of heat transfer medium from the hot thermal reservoir then occurs as represented by point 4-1 in FIG. 1 and FIG. 3B, and the cycle would start again as represented by point t5 in FIG. 3A. In the two figures, vertical lines between the two figures are provided that associate the temperature in the system (FIG. 3B) to specific time points shown in FIG. 3A.

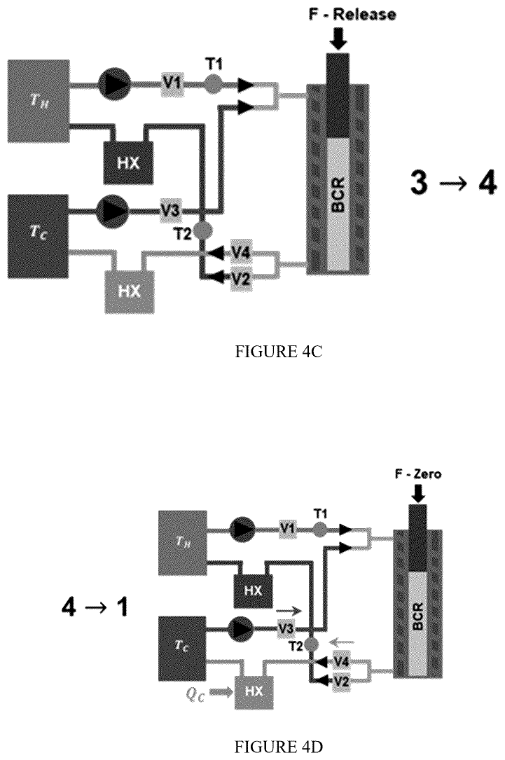

FIGS. 4A-D provides, collectively, a schematic divided into four panels that represents one fully cycle. The stages are associated with compression (FIG. 4A), heat transfer with hot thermal reservoir fluid (FIG. 4B), decompression (FIG. 4C), and heat transfer (FIG. 4D). The panels represent each process for exemplary heat transfer pump in accordance with a reversed Brayton cycle. The description of the stages align with what is described in FIGS. 1-3, wherein compression (i.e., hydrostatic pressure applied to the barocaloric material, FIG. 4A) indicates heat transfer medium flow and pressure status for stage “1-2” in the earlier figures. Continuing, heat transfer (FIG. 4B) indicates flow and pressure for stage “2-3” in those figures. Also, decompression (i.e., hydrostatic pressure released, FIG. 4C) represents pressure release/decompression at stage “3-4”. And finally, heat transfer/input (FIG. 4D) represents the barocaloric material absorbing heat from the heat transfer medium as the barocaloric material remains in its decompressed state. In the panels, the flow of heat transfer medium is controlled by valves, V1-V4. T₁ indicates the transfer medium temperature entering the barocaloric refrigerant core, and T₂ is the temperature of the heat transfer medium upon exiting the barocaloric refrigerant core.

In viewing the 4 parts (FIGS. 4A-D) making up the cycle, it will be appreciated that the arrangement of structures such as an inlet (also referred to as fluid inlet) and an exit (also referred to as fluid outlet) is not limited to what is shown in later figures provided herein. In an exemplary valve arrangement, the valves control entry of hot and cold fluid (i.e., in each case, referred to as heat transfer medium) into and exiting out of the barocaloric refrigerant core, via inlet 5 and exit 7, respectively. Herein, a line through which heat transfer medium enters the barocaloric refrigerant core is referred to as a supply line. A line through which heat transfer medium is transferred away from the barocaloric refrigerant core to the respective thermal reservoirs is referred to as a return line.

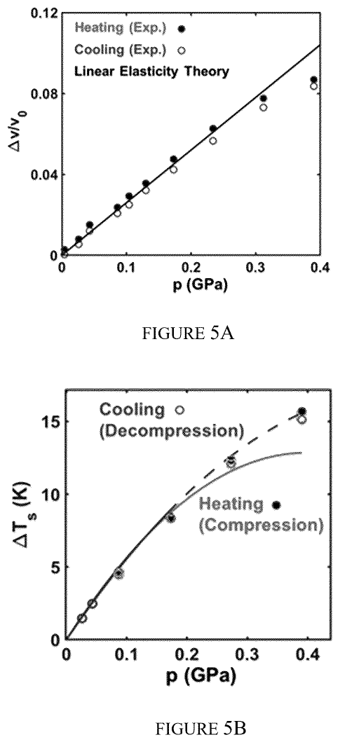

FIG. 5A shows the relative volume change of the barocaloric material as a function of applied pressure. FIG. 5B shows the adiabatic temperature change of the barocaloric material as a function of applied pressure. Here, it will be seen that the differences in ΔT between cooling upon decompression and heating upon compression account for a significant temperature gradient. As with FIGS. 2 and 3, FIGS. 5A and 5B demonstrate the modeling under which the current embodiments are able to perform favorably.

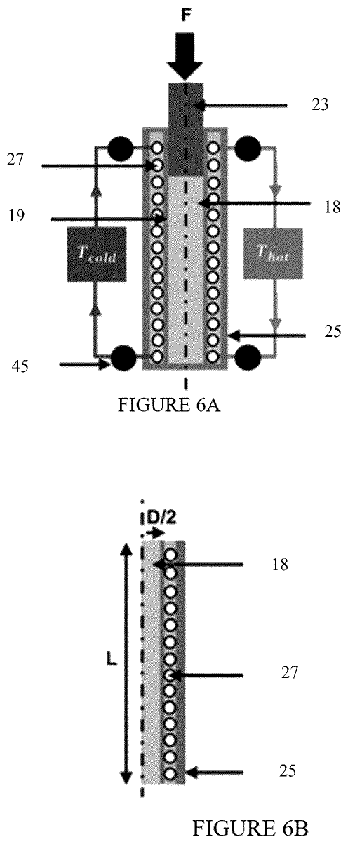

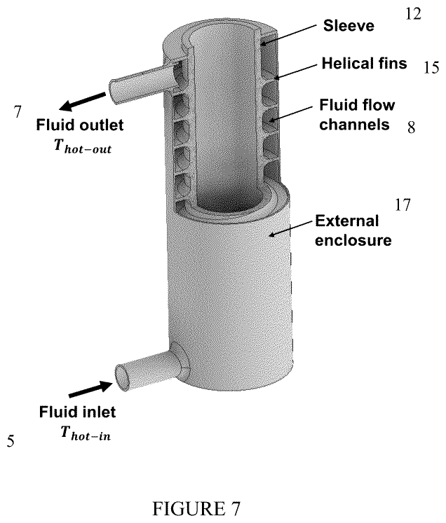

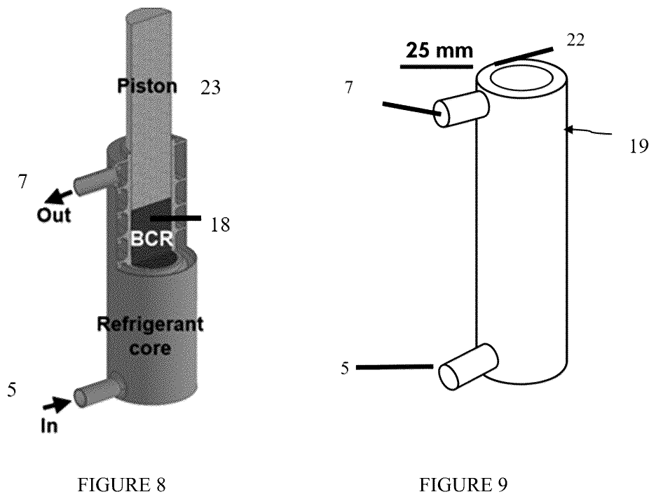

Continuing with the design of the heat pumps disclosed herein, FIG. 6A provides a schematic of a heat pump according to present embodiments. In some embodiments, hydrostatic pressure is produced and exerted upon the barocaloric material by applying a mechanical force, F, upon the barocaloric material. This force may be exerted by a reciprocating arm, which in some embodiments is a hydraulically-driven piston. As also seen in FIG. 7 and FIG. 8, the barocaloric refrigerant core 19 may be hollow with one closed end and one open end. The piston enters the hollow space of the rigid barocaloric refrigerant core 19 through the open end, and contacts the barocaloric material which is positioned in said hollow space. Accordingly, the barocaloric material is confined inside the barocaloric refrigerant core 19, which has a low thermal mass, which in some embodiments is formed of Ti, where the barocaloric material undergoes repeated cycles of alternating compression/decompression phases under force exerted upon it by the piston, wherein the thermodynamic cycle can be characterized as a reversed Brayton cycle. In this manner, an extent of heat transfer created by these cycles can be characterized by an equivalent heat transfer coefficient, h, as the heat transfer medium 27 receives heat from the barocaloric material 18.

FIG. 6B illustrates a partial schematic view of the heat pump in FIG. 6A. The inner surface defining a hollow space for the barocaloric material of the refrigerant core has a length, L, and a diameter, D. In an exemplary heat pump according to present embodiments, the barocaloric material has a mass of 10 g, and the barocaloric refrigerant core 19 has a L/D ratio of 10:1. For an exemplary operating pressure of 0.1 GPa and 293 K ambient temperature, the relationship between Tₕₒₜ and T_{cold} representing heat transfer to and from the barocaloric material is expressed as T_{cold}=Tₕₒₜ−ΔTₛ/2, which produces a value of h=100 W m⁻²K⁻¹.

### Exemplary Barocaloric Heat Pump

FIG. 7 shows a CAD model of a sectional view of a refrigerant core for the subject devices. Titanium (Ti) is a suitable material for the refrigerant core due to its ultra-high strength, relatively low density, and good thermal properties. For the device used in examples discussed below, the titanium refrigerant core was fabricated on a conventional laser powder bed fusion additive manufacturing machine using Ti-6Al-4V powder feedstock with particles from 15-45 μm (Carpenter Additive, Philadelphia, PA). As shown in FIG. 7, the barocaloric refrigerant core 19, also having an external surface or enclosure denoted in the figure, comprises a sleeve 12 which allows the barocaloric material to be loaded in a position where it can undergo compression/decompression cycles, resulting in heat transfer with the circulating heat transfer medium and vice versa. In some embodiments, the outer wall of the enclosure forming the barocaloric refrigerant core 19 has a thickness, wherein a plurality of channels 8 may be formed integrally within the wall thickness to permit circulation of the heat transfer medium. If a cylindrical design is optionally selected for the barocaloric refrigerant core 19, a plurality of helical fins 15 may be formed within the wall thickness to further define the flow channels 8. FIG. 7 also shows inlet 5 and exit 7 through which hot transfer medium (e.g., ethylene glycol) is received at a lower temperature, and by which the heat transfer medium exits the barocaloric refrigerant core 19 at a higher temperature as a result of compression of the barocaloric material.

FIG. 8 is another a partial cross-section of a heat pump showing inlet 5, exit 7, and barocaloric material (BC refrigerant, or BCR) positioned in the refrigerant core. The compression of the barocaloric material 18 can be achieved with a mechanical piston arrangement using an automatic hydraulic press 21 for compressing and decompressing cyclically the barocaloric material (core length: L, diameter: D) to generate the hydrostatic pressure in the barocaloric material (also referred to as BC refrigerant) followed by release of pressure.

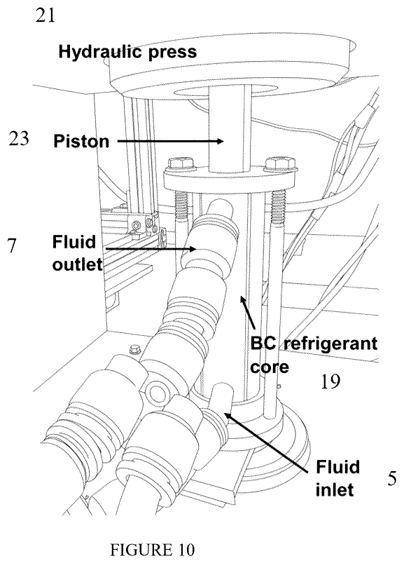

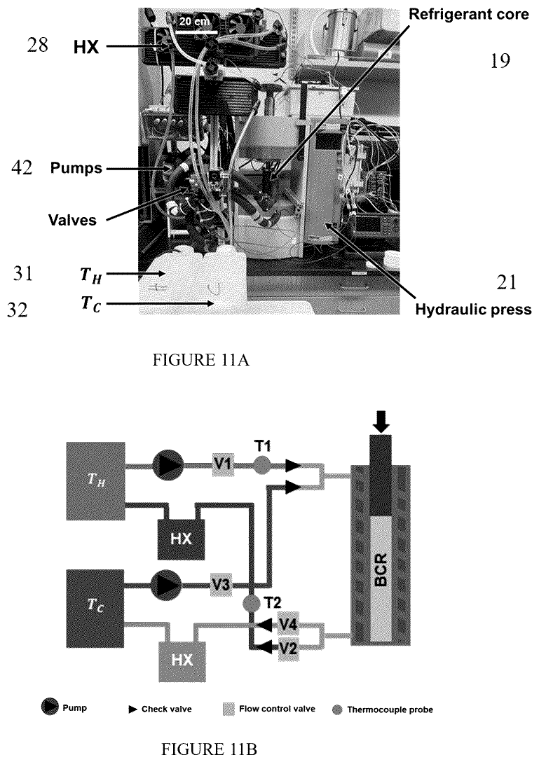

FIG. 9 illustrates the exterior of a barocaloric refrigerant core 19, according to present embodiments, showing the inlet 5, exit 7, configured to join with tubing (see FIG. 10) through which the heat transfer medium travels between the thermal reservoirs and the refrigerant core. FIG. 9 also shows an opening 22 through which the barocaloric material 18 is positioned within the sleeve 12 described in FIG. 7, and through which the piston as shown in FIG. 8 contacts the barocaloric material in a reciprocating manner.

FIG. 10 is a photograph of an exemplary barocaloric refrigerant core configuration connected with a fluid circulation system as part of a heat transfer pump 1. Pictured here are the inlet 5 and exit 7. A hydraulic press 21 driving a piston 23 are shown in relation to the barocaloric refrigerant core 19 and an inner sleeve 12 (as seen in FIG. 7). In some embodiments, the heat transfer medium flows through channels 8 positioned between the outer surface of sleeve 12 and the inner surface of barocaloric refrigerant core, wherein the sleeve and the barocaloric refrigerant core form a hollow enclosure capable of housing the barocaloric material and operating up to a hydrostatic pressure of 0.25 GPa, at least.

FIG. 11A shows a photograph of several components of an exemplary heat transfer pump 1 and related system. Related to this, FIG. 11B provides a schematic of the structural and operational relationships among several components. V_{Heat transfer} between the wall of the barocaloric refrigerant core 19 and the thermal reservoirs 31 and 32 is characterized by an effective heat transfer coefficient. In a variety of aspects, the operation of heat transfer pumps according to the present embodiments is dictated by device parameters including the cycle frequency, applied hydrostatic pressure, hot and cold thermal reservoir temperatures, and heat transfer coefficient between components. As discussed further below, a heat exchanger (HX) 28 is provided that removes heat from the transfer medium traveling by operation of the pumps, thereby maintaining the temperatures of the thermal reservoirs at intended values. FIG. 11B provides additional schematic information referencing how flow is created in the system and temperatures of the hot fluid transfer medium at inlet 5 and exit 7 are established and measured.

In an alternative embodiment, FIG. 11C provides a cross-sectional view of a barocaloric refrigerant core taken along a longitudinal axis of the core shown in previous figures, including FIG. 8. In FIG. 11C, circulation of the heat transfer medium occurs via helical channels in the barocaloric refrigerant core as shown in FIG. 7. In this way, heat transfer fluid alternately coming from the hot thermal reservoir 31 and cold thermal reservoir 32, respectively, establish the heat rejection (associated with compression of the barocaloric material) and heat input (associated with decompression of that material), respectively. In some embodiments, separate ports are used for hot transfer medium and cold transfer medium.

Still further, FIG. 11D provides a cross-sectional view of another alternative embodiment. Here, a solid material can act as a heat transfer medium, wherein the heat obtained from compression of the barocaloric material (or the heat absorbed in decompression) is transferred via alternating mechanical contact between the barocaloric refrigerant core 19 and the two thermal reservoirs, 31 and 32. As persons with ordinary skill in the art will appreciate, heat transfer coefficients between the barocaloric refrigerant core 19 and the alternating solid heat transfer contacts will determine the extent and efficiency of thermal transfer according to this embodiment.

It will be appreciated that several valve management options exist for achieving the desired circulation of heat transfer medium. In some embodiments, a supply line may be arranged with a first supply line valve to permit flow of liquid heat transfer medium from the hot thermal reservoir 31 into the barocaloric refrigerant core 19 via inlet 5, while a second path that communicates with the supply line may be arranged with a second supply line valve to permit flow from the cold thermal reservoir 32 into the barocaloric refrigerant core via inlet 5. As known in the art, first and second supply line valves may be configured as a 3-way valve with actuator (not shown) allowing one valve to be opened while the other is closed. In cases where the first valve is open and the second valve is closed in the supply line, this would tend to coincide with heat transfer medium being supplied during a decompression phase, for example, in that the relatively warmer heat transfer medium supplies energy needed as the barocaloric material is decompressed. Conversely, in cases where the second valve is open and the first valve is closed in the supply line, this would tend to coincide with heat transfer medium being supplied during a compression phase, in that the relatively cooler heat transfer medium entering the barocaloric refrigerant core 19 from the cold thermal reservoir 32 is more capable of absorbing the energy produced as heat as the barocaloric material is compressed.

In the latter case (compression of the barocaloric material 18), heat transfer medium will exit the barocaloric refrigerant core via exit 7 and travel through a return line to the hot thermal reservoir 31. In that the heat transfer medium has just accepted energy in the form of heat while circulating through the barocaloric refrigerant core 19 during the compression phase, its temperature will be higher relative to the heat transfer medium otherwise occupying the hot thermal reservoir. In view of this positive temperature differential at the time of heat/energy extraction, the heat exchanger 28 removes excess heat from the heat transfer medium that was exposed to the compression phase, and the overall effect is removing heat from the environment. Conversely, in cases where heat transfer fluid is exiting the barocaloric refrigerant core 19 following the decompression phase, it may return to the cold thermal reservoir 32 via the return line. As with the supply line, the return line may be configured with a 3-way valve with actuator (not shown) allowing one valve to be opened while the other is closed, to allow for alternating return to the hot thermal reservoir or cold thermal reservoir, depending on which phase has just been completed (i.e., an open valve to the hot thermal reservoir following compression or an open valve to the cold thermal reservoir following decompression).

Stated differently, in some embodiments, in connection with a compression phase, cooler heat transfer medium originates from the cold thermal reservoir 32 and enters the barocaloric refrigerant core 19. After circulating through the barocaloric refrigerant core 19, the heat transfer medium exits the barocaloric refrigerant core through exit 7 at a warmer temperature than the heat transfer medium of the hot thermal reservoir because of heat released from the barocaloric material during compression. In connection with returning to the hot thermal reservoir, the heat exchanger transfers energy in the form of heat from the warmer heat transfer medium. Thus, during compression, a transfer of energy away from the barocaloric material allows the heat pump to cool an environment. Focusing on the reverse part of the cycle, the decompression phase brings warmer heat transfer medium from the hot thermal reservoir, which enters the barocaloric refrigerant core. After circulating through the barocaloric refrigerant core, the heat transfer medium exits the barocaloric refrigerant core at a cooler temperature due to heat being absorbed by the barocaloric material 18 from the heat transfer medium during decompression, and the heat transfer medium then returns to the cold thermal reservoir.

The following examples are provided to further illustrate the configuration and operation of the barocaloric heat pumps according to present embodiments.

### EXAMPLES

All examples provided herein are meant as illustrative of various aspects of multiple embodiments and alternatives related to the disclosures herein. In this way, the examples are non-limiting and merely characteristic of a range of devices, systems, and methods that can be practiced using the present embodiments.

In the examples, NBR served as the barocaloric material positioned within the barocaloric refrigerant core. This came in powder form in a particle size range of 200-600 μm (Genan Corporation, Houston, Texas). Table 2 lists certain relevant physicochemical properties of NBR.
Thermal Conductivity (k) 0.235 W m⁻¹K⁻¹
Specific Heat Capacity (Cp) 1240 J Kg⁻¹K⁻¹
Thermal expansion coefficient (α_{τ}) 6.11×10⁻⁴ K⁻¹
Volumetric Compressibility (β′) 0.598 GPa⁻¹
Density (p) 1390 kg m⁻³
Bulk Modulus (B) 2.41 GPa

It will be appreciated that a range of barocaloric material classes could be used as a barocaloric material housed within the barocaloric refrigerant core, without departing from the scope of present embodiments. These include, but are not necessarily limited to, polymers, thermoplastic elastomers, plastic crystals, n-alkanes, spin-crossovers, hybrid organic-inorganic.
perovskites, superionic conductors, ferroelectrics, ferroelastic fluorides and oxyfluorides, and magnetostructural materials.

Also, in the examples, ethylene glycol (EG) served as the heat transfer medium circulating through the fluid flow channels 8, in addition to being stored in both the hot thermal reservoir 31 and the cold thermal reservoir 32. The thermal reservoirs were formed of polypropylene material. EG was circulated through the heat transfer pump, via fluid flow channels surrounding the refrigerant core, using one or more peristaltic pumps 42 with an exemplary flow rate of 250 mL/min. or higher, up to a maximum flow rate of 750 mL/minute in some embodiments. Each pump may be operated through a microcontroller executing machine-readable instructions and controlled by DC solenoid valves that were operated simultaneously with the pumps. PTFE tubing was the conduit for all fluid transport, with rubber insulation 25 (FIG. 6A) added to minimize heat lost his surroundings.

### Example—Dynamic Operation of the Heat Transfer Pump

In accordance with the experimental setup noted above, the balancing of heat transfer allowed the temperatures of the hot thermal reservoir (TH), 31, and of the cold thermal reservoir (Tc), 32 to be maintained at constant averages. The heat exchanger (HX) 28 as viewed in FIG. 11A was placed inline in the hot fluid circulation loop to remove heat gained by the transfer medium upon exiting the refrigerant core and prevent continuous heating of the hot thermal reservoir, as also shown schematically in FIG. 11B. In parallel, a similar heat exchanger (HX) was utilized to prevent continuous heating of the cold thermal reservoir 32, allowing this to be maintained at a constant Tc of 293K for these examples. Temperature of the inlet 5 and exit 7 for entering and leaving the refrigerant core were measured by thermocouple, with instantaneous transient temperatures of the thermal reservoirs, 31 and 32, measured with K-type thermal couples.

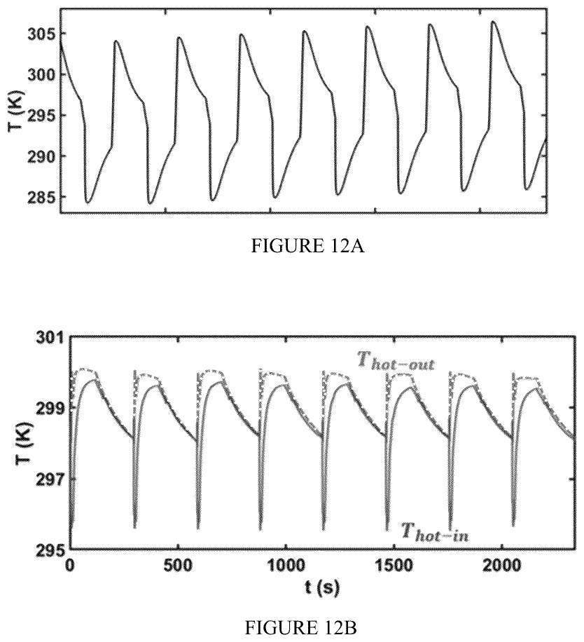

FIG. 12A shows direct temperature change of the barocaloric refrigerant through various cycles of decompression (nadir) and compression (peak), as a function of time for multiple device cycles under specific operating conditions, which were p=0.25 GPa, FR=500 ml min⁻¹, and f=3.3 mHz (frequency) after attainment of quasi-steady-state. Quasi-steady-state is defined as the equilibrium of heat transfer between the refrigerant core and circulating heat transfer medium, and the external heat loss from the refrigerant core to the surroundings. Throughout the experiment, the instantaneous temperature difference between the inlet 5 and the exit 7 from the refrigerant core was determined to fall with a variance of less than +/−1% compared to the previous cycle, as a condition for obtaining temperatures T₁ and T₂.

FIG. 12B depicts temperature changes along the same cycle representative of temperature at the inlet (Tₕₒₜ₋ᵢₙ) and exit (Tₕₒₜ₋ₒᵤₜ) of the heat transfer medium as a function of time under a ΔTₛₚₐₙ of 1 K. As with FIG. 12A, results for FIG. 12B are shown for an experiment performed under p=0.25 GPa, VFR=500 ml min⁻¹, and f=3.3 mHz after system attained quasi steady state.

### Example—SHP and COP

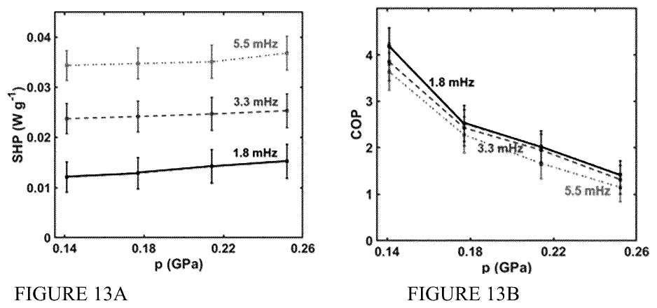

FIG. 13A graphs results for SHP as a function of pressure at three separate cycle frequencies (5.5 mHz, 3.3 mHz, and 1.8 mHz). FIG. 13B graphs results for COP under the same pressure parameters and cycle frequencies. As shown in FIG. 13A a maximum SHP (0.036 W g⁻¹) is observable at highest operating frequency (5.5 mHz) at a pressure of 0.25 GPa, reflecting that SHP increases slightly with increasing operating pressure. FIG. 13B indicates that COP as a function of pressure demonstrated an opposite behavior to SHP, in that COP value trended lower at high frequencies due to low contact time between the heat transfer medium and the thermal reservoirs 31 and 32. This behavior reflects the elastomeric behavior of the barocaloric material, as it requires more mechanical work input to compress the material at higher working pressure.

It will be understood that the embodiments described herein are not limited in their application to the details of the teachings and descriptions set forth, or as illustrated in the accompanying figures. Rather, it will be understood that the present embodiments and alternatives, as described and claimed herein, are capable of being practiced or carried out in various ways. Also, it is to be understood that words and phrases used herein are for the purpose of description and should not be regarded as limiting. The use herein of such words and phrases as “such as,” “comprising,” “e.g.,” “containing,” or “having” and variations of those words is meant to encompass the items listed thereafter, and equivalents of those, as well as additional items. The use of “including” (or, “include,” etc.) should be interpreted as “including but not limited to.”

Accordingly, the foregoing descriptions of several embodiments and alternatives are meant to illustrate, rather than to serve as limits on the scope of what has been disclosed herein. It will be understood by those having ordinary skill in the art that modifications and variations of these embodiments are reasonably possible in light of the above teachings and descriptions.

What is claimed is:

1. A heat pump using a compressible barocaloric material, comprising:
a barocaloric refrigerant core having an opening;
a barocaloric material positioned within the barocaloric refrigerant core;
an arm that moves reciprocally within the barocaloric refrigerant core to alternately compress and decompress the barocaloric material;
at least one pump that circulates heat transfer medium into the barocaloric refrigerant core via an inlet, through the barocaloric refrigerant core, and out of the barocaloric refrigerant core via an exit;
at least two thermal reservoirs for storing the heat transfer medium and for receiving the heat transfer medium exiting the barocaloric refrigerant core; and
a heat exchanger positioned exterior to the barocaloric refrigerant core to extract energy from the heat transfer medium flowing out of the barocaloric refrigerant core wherein a positive temperature differential exists at the time of the extraction due to the barocaloric material releasing energy to the heat transfer medium during a compression phase;
wherein one of the thermal reservoirs is a cold thermal reservoir that receives heat transfer medium exiting the barocaloric refrigerant core at a first temperature following decompression of the barocaloric material, and delivers heat transfer medium to the barocaloric refrigerant core via the inlet,
wherein one of the thermal reservoirs is a hot thermal reservoir that receives heat transfer medium exiting the barocaloric refrigerant core at a second temperature following compression of the barocaloric material and delivers heat transfer medium to the inlet, and
wherein the first temperature is lower than the second temperature due to the barocaloric material absorbing energy from the heat transfer medium during decompression.

2. The heat pump of claim 1, wherein the opening of the barocaloric refrigerant core is positioned at one end of the barocaloric refrigerant core.

3. The heat pump of claim 1, wherein the arm comprises a hydraulically driven piston.

4. The heat pump of claim 3, further comprising a sleeve arranged coaxially with an inner surface of the barocaloric refrigerant core, wherein the sleeve defines a space with a sleeve opening aligned with the barocaloric refrigerant core opening, wherein the sleeve opening is configured to receive and hold the barocaloric material and one or more sides of the sleeve physically separate the barocaloric material from the heat transfer medium while allowing thermal contact between the barocaloric material and the heat transfer medium.

5. The heat pump of claim 4, wherein the reciprocating motion of the piston is parallel to longitudinal axes of the sleeve and barocaloric refrigerant core.

6. The heat pump of claim 4, wherein the barocaloric refrigerant core and the sleeve are cylindrical, and the barocaloric refrigerant core further comprises flow channels through which the heat transfer medium circulates.

7. The heat pump of claim 6, wherein the flow channels form helical paths formed in the barocaloric refrigerant core external to the sleeve.

8. The heat pump of claim 6, further comprising a plurality of fins formed within the wall thickness of the barocaloric refrigerant core and defining the helical flow channels.

9. The heat pump of claim 1, wherein the barocaloric material is nitrile butadiene rubber and the heat transfer medium is ethylene glycol.

10. A heat transfer method for transferring heat from an environment, comprising:
positioning a compressible barocaloric material in a barocaloric refrigerant core;
applying multiple cycles of dynamic mechanical force to the barocaloric material, wherein each cycle comprises alternating phases of hydrostatic compression and decompression causing the barocaloric material to undergo adiabatic temperature changes;
exposing the barocaloric material to thermal contact with a heat transfer medium; and
circulating the heat transfer medium out of the barocaloric refrigerant core to a thermal reservoir,
after a compression phase, directing the circulating heat transfer medium to a first thermal reservoir referred to as a hot thermal reservoir, and further comprising extracting energy as heat from the heat transfer medium using a heat exchanger positioned exterior to the barocaloric refrigerant core;
after a decompression phase, directing the circulating heat transfer medium to a second thermal reservoir referred to as a cold thermal reservoir;
directing the heat transfer medium from the hot thermal reservoir to the barocaloric refrigerant core prior to a decompression phase; and
directing the heat transfer medium from the cold thermal reservoir to the barocaloric refrigerant core prior to a compression phase.

11. The heat transfer method of claim 10, wherein following the heat transfer medium being thermally exposed to the barocaloric material during a decompression phase, heat transfer medium exits the barocaloric refrigerant core via the outlet at a lower temperature than while circulating through the heat transfer medium during the decompression phase due to energy being absorbed by the barocaloric material from the heat transfer medium during decompression.

12. The heat transfer method of claim 10, wherein following the heat transfer medium being thermally exposed to the barocaloric material during a compression phase, heat transfer medium exits the barocaloric refrigerant core via the outlet at a higher temperature than while circulating through the heat transfer medium during the compression phase due to energy being released by the barocaloric material during compression.

13. The heat transfer method of claim 10, wherein the dynamic mechanical force associated with compression phases comprises force applied from a hydraulically driven piston.

14. The heat transfer method of claim 10, wherein the heat transfer medium is a flowing liquid separated from the barocaloric material by a sleeve positioned outside the barocaloric refrigerant core.

15. The heat transfer method of claim 10, wherein exposing the barocaloric material to thermal contact with a heat transfer medium comprises indirect thermal contact as the heat transfer medium flows into, through, and out of the barocaloric refrigerant core.

16. A heat pump, comprising:
a barocaloric refrigerant core having an opening;
a barocaloric material positioned within the barocaloric refrigerant core;
an arm that moves reciprocally within the barocaloric refrigerant core to alternately compress and decompress the barocaloric material;
heat transfer media in thermal contact with the barocaloric material; and
two thermal reservoirs comprising the heat transfer media and configured to undergo alternating mechanical contact with the barocaloric refrigerant core,
wherein the thermal reservoirs are formed of solid heat conducting material such that energy absorbed by the first thermal reservoir during compression of the barocaloric material is transferred to a heat exchanger, and energy from the second thermal reservoir is transferred to the barocaloric material during decompression of the barocaloric material, as the respective first and second thermal reservoirs undergo alternating mechanical contact with the barocaloric refrigerant core.

17. The heat pump of claim 16, wherein the arm comprises a hydraulically driven piston.

18. The heat pump of claim 17, wherein the piston undergoes reciprocating motion parallel to a longitudinal axis of the barocaloric refrigerant core.
